(19) United States
(12) Patent Application Publication
(10) Pub. No.: US 2024/0428064 A1
(43) Pub. Date: Dec. 26, 2024

(54) SYSTEM AND APPARATUS FOR INTELLIGENT PHOTONIC COMPUTING LIFELONG LEARNING ARCHITECTURE

(71) Applicant: TSINGHUA UNIVERSITY, Beijing (CN)

(72) Inventors: Lu FANG, Beijing (CN); Yuan CHENG, Beijing (CN)

(21) Appl. No.: 18/749,238

(22) Filed: Jun. 20, 2024

(30) Foreign Application Priority Data
Jun. 20, 2023 (CN) 202310732431.6

(51) Int. Cl. G06N 3/067; G06N 3/0464; G06N 3/084

(52) U.S. Cl. CPC G06N 3/067; G06N 3/0464; G06N 3/084

(57) ABSTRACT

The present disclosure relates to a system and an apparatus for an intelligent photonic computing lifelong learning architecture. The system includes: a multi-spectrum representation layer configured to transfer originally input electronic signals including multiple tasks into coherent light with different wavelengths by multi-spectrum representations; a lifelong learning optical neural network layer including cascaded sparse optical convolutional layers in a Fourier plane of an optical system, in which final spatial optical signals are output through the lifelong learning optical neural network layer by performing multi-task step-by-step training of the lifelong learning optical neural network layer on the coherent light with different wavelengths input into the cascaded sparse optical convolutional layers; and an electronic network read-out layer configured to recognize final optical output data obtained by detecting the final spatial optical signals, to obtain multi-task recognition results.

### CROSS REFERENCE TO RELATED APPLICATION

This application claims priority to Chinese Patent Application No. 2023107324316, filed on Jun. 20, 2023, the entire disclosure of which is incorporated by reference herein.

### TECHNICAL FIELD

The present disclosure relates to a field of machine learning task technologies, and particularly to a system and an apparatus for an intelligent photonic computing lifelong learning architecture.

### BACKGROUND

Machine learning tasks become increasingly diverse and complex fueled by large-scale datasets. One unresolved issue in machine intelligence is how artificial agents could propagate in a smarter manner and have strong learning capabilities to continually learn multi tasks. With end of Moore's law, energy consumption becomes a major barrier to more widespread task promotions of current electronic neural network methods, especially in terminal/edge devices. There is an imminent need to look for next-generation computing modalities to break through physical constraints of electronic artificial neural networks (ANNs). Large-scale intelligence computing is a primary guarantee for implementing increasingly diverse and complex machine learning tasks. Nowadays, artificial intelligence based on conventional electrical computing processors has faced constraints in power consumption walls, hindering them from sustainable performance improvement.

### SUMMARY

In an aspect of the present disclosure, a system for an intelligent photonic computing lifelong learning architecture is provided, and includes a multi-spectrum representation layer, a lifelong learning optical neural network layer, and an electronic network read-out layer, in which,
the multi-spectrum representation layer is configured to transfer originally input electronic signals including multiple tasks into coherent light with different wavelengths by multi-spectrum representations;
the lifelong learning optical neural network layer includes cascaded sparse optical convolutional layers in a Fourier plane of an optical system, in which final spatial optical signals are output through the lifelong learning optical neural network layer by performing multi-task step-by-step training of the lifelong learning optical neural network layer on the coherent light with different wavelengths input into the cascaded sparse optical convolutional layers; and
the electronic network read-out layer is configured to recognize final optical output data obtained by detecting the final spatial optical signals, to obtain multi-task recognition results.

In another aspect of the present disclosure, an apparatus for an intelligent photonic computing lifelong learning architecture is provided, and includes a multi-spectrum representation unit, a beam splitter, mirrors, lens, optical modulation filters, an optical diffractive unit, and an intensity sensor; in which,
electronic signals including multiple tasks are input into the multi-spectrum representation unit to obtain coherent light with different wavelengths by multi-spectrum representations, light propagation of the coherent light with different wavelengths is guided and modulated through the beam splitter, the mirrors, the lens, the optical modulation filters, the optical diffractive unit to obtain final spatial optical signals, the intensity sensor detects the final spatial optical signals to obtain final optical output data, and multi-task recognition results of the final optical output data are obtained through an output plane.

In still another aspect of the present disclosure, a method for an intelligent photonic computing lifelong learning architecture is provided, and includes:
transferring, by a multi-spectrum representation layer, originally input electronic signals including multiple tasks into coherent light with different wavelengths by multi-spectrum representations;
performing multi-task step-by-step training of the lifelong learning optical neural network layer on the coherent light with different wavelengths input into cascaded sparse optical convolutional layers and outputting final spatial optical signals through a lifelong learning optical neural network layer, in which the lifelong learning optical neural network layer includes cascaded sparse optical convolutional layers in a Fourier plane of an optical system; and
recognizing, by an electronic network read-out layer, final optical output data obtained by detecting the final spatial optical signals, to obtain multi-task recognition results.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic diagram illustrating a system for an intelligent photonic computing lifelong learning architecture according to an embodiment of the present disclosure.

FIG. 2 is a schematic diagram illustrating a learning principle of a photonic lifelong learning network according to an embodiment of the present disclosure.

FIG. 3 is a schematic diagram illustrating an architecture of a photonic lifelong learning network L²ONN according to an embodiment of the present disclosure.

FIG. 4 is a schematic diagram illustrating photonic lifelong learning of an L²ONN on representative visual classification tasks according to an embodiment of the present disclosure.

FIG. 5 is a schematic diagram illustrating a numerical performance evaluation on L²ONN according to an embodiment of the present disclosure.

FIG. 6 is a schematic diagram illustrating an apparatus for an intelligent photonic computing lifelong learning architecture according to an embodiment of the present disclosure.

### DETAILED DESCRIPTION

It should be noted that, without conflict, embodiments of the present disclosure and features in embodiments can be combined with each other. Reference will be made in detail to embodiments of the present disclosure with reference to the accompanying drawings and embodiments.

In order to facilitate a better understanding of the present disclosure by those skilled in the art, descriptions will be made clearly and completely on the technical solutions in embodiments of the present disclosure, in combination with the accompanying drawings in embodiments of the present disclosure. Obviously, the described embodiments are only a part of embodiments of the present disclosure, not all embodiments. Based on embodiments in the present disclosure, all other embodiments obtained by those ordinary skilled in the art without creative labor shall fall within the scope of protection of the present disclosure.

Photonic computing is such a computing modality that may overcome inherent constraints of electrical computing and improve energy efficiency, processing speed, and computational throughput by several orders of magnitude. Such extraordinary properties have been exploited to construct application-specific optical architectures for solving fundamental mathematical and signal processing problems with performances far beyond those of existing electronic processors. Simple visual processing tasks such as hand-written digit recognition and saliency detection have been effectively validated by wave-optics simulations or small-scale photonic computing systems. Meanwhile, some works combine photonic computing units with a variety of electronic ANNs to enhance a scale and flexibility of optical neural networks (ONNs), e.g., deep optics, Fourier neural networks, and hybrid optical-electronic convolutional neural networks. However, existing optics-based implementations are limited to a small range of applications and cannot continually learn experiential knowledge on multiple tasks to adapt to new environments. A main reason is that they inherit a widespread problem of conventional photonic computing systems, which are prone to learn new knowledges interfering with formerly learned knowledges, rapidly forget previously learned tasks when trained on new tasks, i.e., “catastrophic forgetting”. These existing ONNs fail to fully exploit intrinsic properties in sparsity and parallelism of optics, which ultimately results in poor network capacity and scalability for large-scale machine learning tasks.

In contrast, humans possess an ability to incrementally absorb, learn and memorize knowledge. In particular, neurons and synapses perform work only when there are tasks to deal with, in which two important neurocognitive mechanisms participate: sparse neuron connectivity and parallelly task processing, together contribute to a lifelong learning in a human brain. Accordingly, in the ONNs, it can be naturally promoted from biological neurons to photonic neurons based on intrinsic sparsity and parallelism properties of optical operators. A photonic computing frame imitating a structure and a function of the human brain demonstrates its potential to alleviate the aforementioned issues, which shows more advantages than electronic ANNs in constructing a viable lifelong learning computing system.

A system and an apparatus for an intelligent photonic computing lifelong learning architecture according to embodiments of the present disclosure are described below with reference to the accompany drawings.

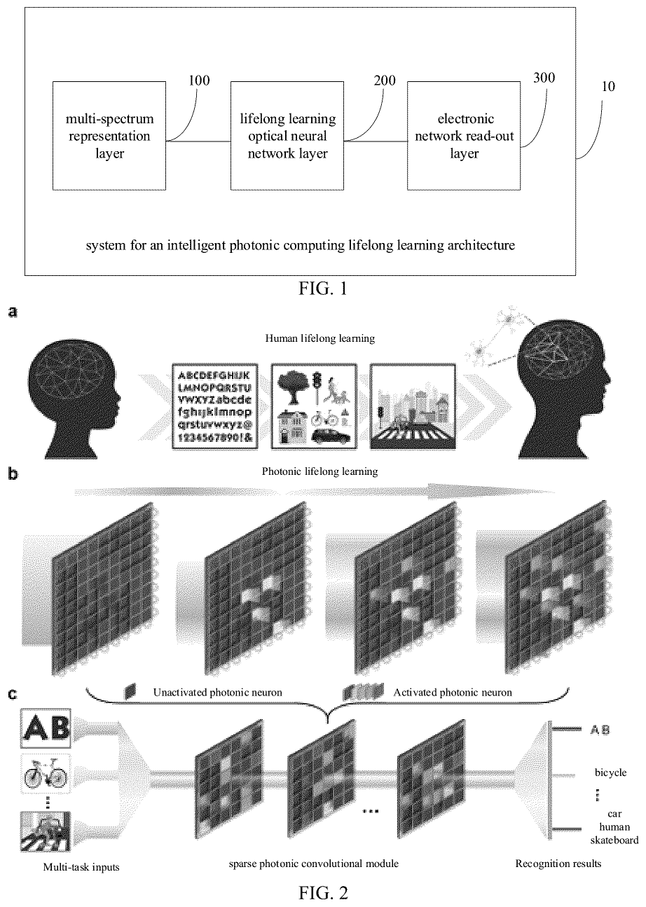

FIG. 1 is a schematic diagram illustrating a system for an intelligent photonic computing lifelong learning architecture according to an embodiment of the present disclosure.

As illustrated in FIG. 1, the system 10 includes a multi-spectrum representation layer 100, a lifelong learning optical neural network layer 200, and an electronic network read-out layer 300.

The multi-spectrum representation layer 100 is configured to transfer originally input electronic signals including multiple tasks into coherent light with different wavelengths by multi-spectrum representations.

The lifelong learning optical neural network layer 200 includes cascaded sparse optical convolutional layers in a Fourier plane of an optical system, final spatial optical signals are output through the lifelong learning optical neural network layer 200 by performing multi-task step-by-step training of the lifelong learning optical neural network layer on the coherent light with different wavelengths input into the cascaded sparse optical convolutional layers; and

The electronic network read-out layer 300 is configured to recognize final optical output data obtained by detecting the final spatial optical signals, to obtain multi-task recognition results.

It is understandable that, a principle of photonic lifelong learning L²ONN provided in the present disclosure is shown in FIG. 2. Neuromorphically inspired by a brain, L²ONN continually learns multiple tasks in one model with light-speed efficient computation. The present disclosure develops unique characteristics of optical sparsity and multi-spectrum representations for the first time in photonic computing architecture, endowing ONN with lifelong learning ability similar to that of the human brain.

In an embodiment of the present disclosure, as illustrated in FIG. 2, which is the principle of the photonic lifelong learning according to an embodiment of the present disclosure, a figure a in FIG. 2 is an illustration of human lifelong learning. It may be known that the brain can incrementally absorb, learn and memorize knowledge throughout its lifespan. Neurons and synapses only function when activated by corresponding signals, with active neurons relatively sparse and information transmitted through parallel task-driven. Humans possess an extraordinary capacity to retain memories and gradually absorb new knowledges throughout their lifespan. The brain can progressively absorb, learn and memorize knowledges, e.g., evolving from recognizing basic characters and objects to understanding complex scenes. During learning, the neurons and the synapses are gradually activated and connected to remember specified tasks, which only function when there are task-related external stimuli. In the human brain, the lifelong learning is implemented through sparse neuron connections and parallel task processing.

A figure b in FIG. 2 is a schematic diagram of the photonic lifelong learning provided in the present disclosure. An optical computing module continuously improves its learning ability and memory the knowledges. During an incremental learning process, optical neurons continuously learn and are activated. Input information of different tasks is encoded into the coherent light of different wavelengths, and processed by a sparse photonic convolutional module to obtain final inference results. Each stage of incremental learning activates a new set of photonic neurons. These updated neurons encode newly learned knowledges, and will be consolidated to avoid catastrophic forgetting in future learning, just like human never forgets basic skills that they have learned, e.g. how to ride a bicycle.

A figure c in FIG. 2 is a schematic diagram of L²ONN as provided. Inputs of incremental learning tasks are encoded into a coherent light field with different wavelengths, and parallelly delivered into the cascaded sparse optical convolutional modules. Through light-wave propagation and sparse neuron activation, optical features are further processed, and the inference results are calculated. Along with progressive incremental learning, the L²ONN can obtain versatile experiential knowledges on multiple challenging tasks adapting to new scenarios.

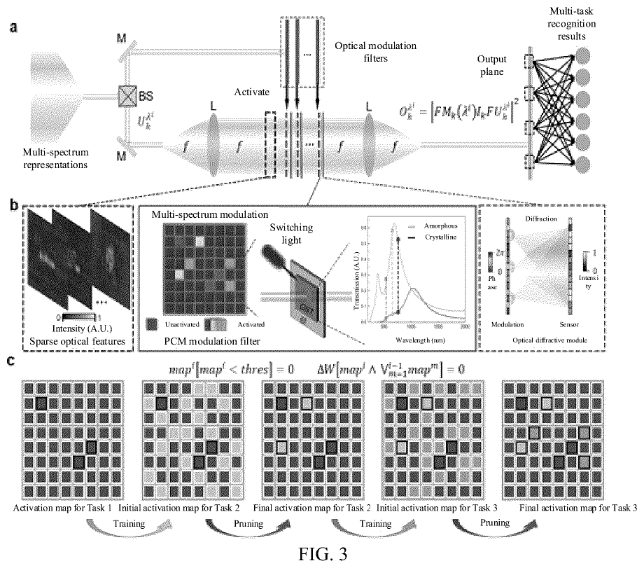

In an embodiment of the present disclosure, as illustrated in FIG. 3, the present disclosure employs phase change materials (PCM)-based sparse optical filters to modulate photonic neuron connections of each single task. And a multi-spectrum light diffraction-based optical convolutional module is constructed to extract multi-task features allocated with different wavelengths. Throughout the architecture, photonic neurons are selectively activated according to the inputs. Unlike existing ONNs trying to imitate ANN structures, the photonic lifelong learning of the L²ONN is initially designed following physical nature of light propagation, to fully explore potentials in photonic computing.

For example, a figure a in FIG. 3 is a schematic diagram illustrating an architecture of a sparse optical convolutional module. Inputs of multi-tasks are projected into the coherent light field with the multi-spectrum representations Uₖ^{λ}^{ⁱ}, that is, original inputs are electrical signals, those projected into the light field are optical signals with the multi-spectrum representations. Abeam splitter (BS), mirrors (M), lens (L) and optical modulation filters are employed to guide and modulate the light propagation. The cascaded sparse optical convolutional layers are realized by configuring the optical modulation filters at a Fourier plane of a 4f optical system. With measuring optical outputs O at the output plane, the final results can be obtained through the electronic network read-out layer. A figure b in FIG. 3 is detailed construction of the sparse optical convolutional layers. Each layer receives sparse features as inputs. The PCM-based filters are all-optically switched, which adaptively perform spatial and spectrum-wise photonic neuron activations. The activated photonic neurons are then connected in the subsequent optical diffractive module. A figure c in FIG. 3 is a training strategy of photonic incremental learning on an 8×8 optical modulation filter. Training of each task initially learns a dense activation map mapⁱ, which is further pruned to a sparse activation map using an intensity threshold thres. The activation map of final learned photonic neurons for each task is retained and stays fixed in the following evolution of learning. The optical modulation filter shares optical weights learned from all tasks.

Specifically, the figure a in FIG. 3 illustrates the overall structure. The principle of the present disclosure is as follows. First, the inputs are transferred into multi-spectrum representations bearing multi-task information, projected to a shared domain, namely, projected to spatial optical representations, and propagated through a light diffraction-based optical computing module. The optical computing module which is cascaded by sparse optical convolutional layers in the Fourier plane of a coherent 4f optical system. Each layer includes the optical modulation filter which is adaptively switched in accordance with different tasks, and a diffractive unit may selectively activate the photonic neurons based on input data. The final spatial light optical outputs of the sparse optical convolutional module are detected by the intensity sensor on the plane, and further fed into the electronic network read-out layer to obtain the recognition results. An implementation of the method may include following steps.

Assuming Uₖ^{λ}^{ⁱ} is a feature representation of a k-th sparse optical convolutional layer on spectrum λⁱ of an i-th task. A 2f system is first adopted and Uₖ^{λ}^{ⁱ} is Fourier transformed into:

U′ₖ^{λ}^{ⁱ}=FUₖ^{λ}^{ⁱ},
where U′ₖ^{λ}^{ⁱ} represents optical feature mapping in a Fourier domain, and F denotes a Fourier transform matrix. Later, U′ₖ^{λ}^{ⁱ} is further modulated by an optical modulation filter:

$${U}_{k}^{{″λ}^{i}} = {I}_{k} ( {λ}^{i} ) {M}_{k} {U}_{k}^{{′λ}^{i}} ,$$

where U″ₖ^{λ}^{ⁱ} represents an optical feature after modulation, Mₖ denotes a phase modulation matrix, Iₖ(λⁱ) denotes intensity modulation matrix, which can dynamically activate or prune photonic neuron connections to enable different tasks. Later, U″ₖ^{λ}^{ⁱ} is Fourier transformed back to a space domain by using another 2f system, whose normalized optical output data Oₖ^{λ}^{ⁱ} is measured by an intensity sensor on an output plane:

$${O}_{k}^{{λ}^{i}} = {\vert {FU}_{k}^{{″λ}^{i}} \vert}^{2} .$$

Except for the last layer namely the electronic network read-out layer, the output of each layer is remapped as an input of the next layer:

$${U}_{k + 1}^{{λ}^{i}} = remap ( {O}_{k}^{{λ}^{i}} ) ,$$

where remap( ) represents a corresponding non-linear operation to a photonic computing. Define a number of layers for optical modules as n (set as 3 in our experiments), the final optical outputs Oₙ^{λ}^{ⁱ} of the sparse optical convolutional module may be detected by the intensity sensor on the plane and cropped into 14×14 small spatial blocks, and the intensity of each spatial block is measured and fed into a 196×10 electronic fully-connected layer to obtain the final recognition results.

Further, the figure b in FIG. 3 analyzes a detailed structure of a single sparse optical convolutional layer. Each layer receives sparse optical features from the previous layer and performs optical convolution. For example, phase change materials (PCM) are adopted for the optical modulation filters to switch both spatial and spectrum-wise activations. These activations are fed to the optical diffractive module to modulate the optical neuron connections. The applied PCM includes GeSbTe (GST) growing on a transparent Si substrate. Each GST cell has two states of amorphous and crystalline with different spectra transmissions, which can be switched instantly by switching light. All-optical control ensures that modulations on the phase and the intensity are performed with minimal delay. Under a same wavelength, the present disclosure defines a GST cell with higher transmission as activated and a GST cell with lower transmission as unactivated.

Further, the figure c in FIG. 3 shows a training strategy of L²ONN using an 8×8 optical modulation filter to achieve a purpose of expected lifelong learning through training. Primitive states of all PCM cells stay unactivated and incrementally activate along with a training process. For each new task, the optical modulation filter initially learns a dense activation map, which is further pruned to a sparse activation map utilizing an intensity threshold thres:

$${map}^{i} [ {map}^{i} < thres ] = 0 ,$$

where mapⁱ denotes an activation map on the i-th task. Only a photonic neuron with the intensity greater than the intensity threshold may remain activated and keep unchanged in the following tasks:

$$Δ W [ {map}^{i} ⋀ {∨}_{m = 1}^{i - 1} {map}^{m} ] = 0 ,$$

where ΔW represents a gradient matrix of backpropagation on optical convolutional weights W, operation ∧ denotes searching coincident cells between two matrixes, operation ∨ denotes gradually merging activation map matrixes. The optical modulation filters share the optical weights learned from all known tasks and gradually obtains empirical knowledges from multiple tasks to adapt to new environments, avoiding the catastrophic forgetting problem. During training, a loss function is defined as:

$$L = {L}_{C E N} ( {P}^{i} , {G}^{i} ) + α {\sum }_{k = 1}^{n} ( {‖ {I}_{k} ( {λ}^{i} ) ‖}^{2} + {‖ {M}_{k} ‖}^{2} ) ,$$

where L_{CEN} represents a softmax cross-entropy loss, Pⁱ and Gⁱ denote network prediction and data truth of the i-th task respectively, and a denotes a normalization coefficient.

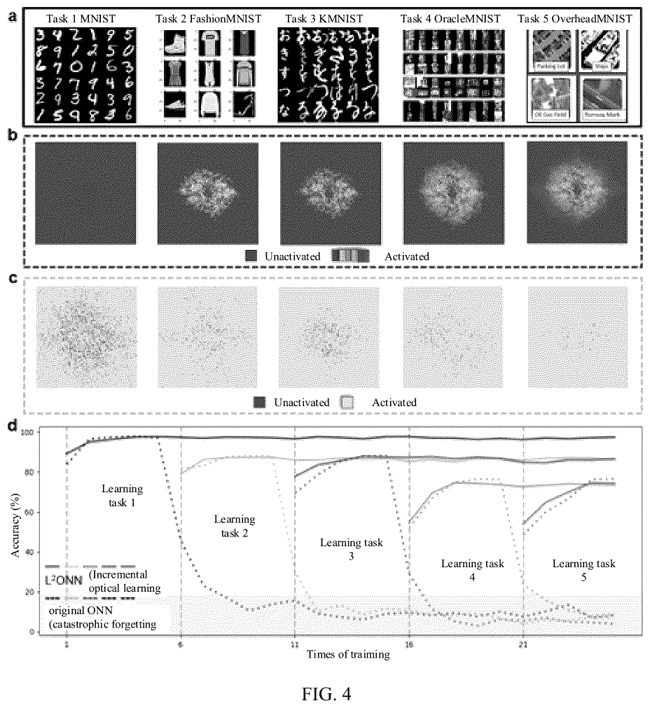

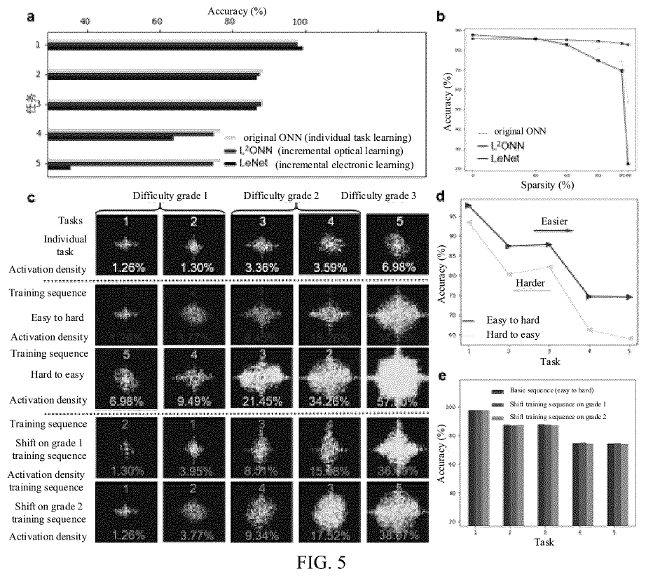

Furthermore, FIG. 4 illustrates photonic lifelong learning of an L²ONN on representative visual classification tasks. A figure a in FIG. 4 illustrates 5 basic MNIST class datasets used for optical incremental learning. A figure b in FIG. 4 and a figure c in FIG. 4 illustrate optical neuron activation maps in a first layer of the L²ONN and the original ONN respectively. With network learning, the photonic neuron connections in the L²ONN are initially sparse and constantly activated, colored with red, yellow, green, blue and purple, respectively, while in the original ONN are quite dense from the first task. A figure d in FIG. 4 illustrates a comparison between training plots of the L²ONN and the original ONN. Each task is trained for 5 epochs, the L²ONN can increment its capabilities and memorize all seen tasks, while an ordinary ONN rapidly forgets what was learned before and falls into a catastrophic forgetting area below 20% accuracy. The present disclosure validates a lifelong learning capability (FIG. 4) and a numerical performance (FIG. 5) of a three-layer L²ONN sized 200×200 on 5 representative vision classification tasks. The figure a in FIG. 4 illustrates 5 basic MNIST class datasets. The present disclosure incrementally trains the L²ONN on these 5 tasks and an evolution on the optical neuron activation maps in the first layer is obtained in the figure b in FIG. 4, which gradually enlarges and remains fixed along with the following task training. For the training of each task, it can be observed that L²ONN only requires a fraction of photonic neuron to be activated to learn its experiential knowledges. For comparison, the present disclosure constructs a three-layer original ONN sized 200×200 and a computational equivalent five-layer electronic network LeNet and learns incrementally in the same way. The figure c in FIG. 4 shows a variation of the photonic neuron activation maps of the original ONN, which keeps dense during the whole training process. The photonic neuron activation of each new task tends to fully occupy the space and interfere with formerly learned neurons, leading to the evident catastrophic forgetting problem. The figure d in FIG. 4 compares convergence plots between the L²ONN and the original ONN, 25 epochs are applied and 5 epochs for each task. Setting below 20% accuracy as a catastrophic forgetting baseline, it can be observed that the original ONN may experience the catastrophic forgetting problem after 2 epochs of training new task, which indicates that the previously learned experiential information has been almost erased. Through network training, the L²ONN continuously learns all seen tasks and obtain its capabilities on new tasks, while the ordinary ONN quickly forgets what was learned before and falls into the catastrophic forgetting area. Using a fixed activation threshold of 0.5, the L²ONN can incrementally learn at most 14 tasks occupying totally 96.3% photonic neuron activations, while achieving more than an order of magnitude higher energy efficiency ratio than the electronic network LeNet-5.

Furthermore, FIG. 5 shows evaluation on the numerical performance of L²ONN. A figure a in FIG. 5 shows accuracy comparison among different benchmarks of the original ONN, the L²ONN and the LeNet. The electronic network LeNet adopts a pruning rate (70%) closed to a minimum sparsity of the L²ONN, and the same training strategy is used to continually learn multiple tasks. A figure b in FIG. 5 shows an evaluation on a relationship between network sparsity and performance with an individual FashionMNIST task. All networks are configured with fixed pruning settings under the same sparsity. A figure c in FIG. 5 shows evolution of activation maps of optical modulation filters with various training sequences. 5 tasks are divided into 3 task difficulty grades according to the photonic neuron activation map required for each individual training (row 1). Tasks 1 and 2, and tasks 3 and 4 share the same grade due to they have the similar activation densities. Based on such criteria, in a figure d in FIG. 5, an impact of training sequences from easy to hard and from hard to easy (rows 2 and 3) on network performance is evaluated, and in a figure e in FIG. 5, an impact of shifts of interior task sequences (rows 4 and 5) on the same difficulty grade on the network performance is further reported.

Furthermore, the figure a in FIG. 5 reports the accuracy comparison among different benchmarks of the original ONN of the individual task training, the L²ONN of incremental optical learning and the electronic ANN (LeNet) of incremental electronic learning. The electronic network LeNet is configured with computations of equivalent scale to the L²ONN, and applied with the pruning rate (70%) similar to the minimum sparsity achieved by the L²ONN and trained with the same training strategy. During the learning process, the L²ONN with highly sparse photonic convolution just loses at most 1.9% accuracy compared with the original ONN with full dense connections, while only using 34.3% parameters of the original ONN to obtain the experiential knowledges of all 5 tasks. As for the comparison on incremental learning capability, the electronic network LeNet just gains a 1.2% accuracy improvement on the first task but gets lower accuracy on all rest of tasks when compared with the L²ONN. More significantly, the electronic ANN suffers a rapid performance degradation from the 4-th task training, due to the lack of inherent sparsity.

Furthermore, a figure b in FIG. 5 evaluates the performance comparison among the original ONN, the L²ONN and the electronic network LeNet with different sparsities on the FashionMNIST task. It can be seen that the electronic network LeNet outperforms ONN-based approaches when the sparsity is below 40%, however, its performance visibly decreases if the sparsity is beyond 60%. In contrast, the L²ONN robustly obtains a competitive accuracy of 82.6% (only 3.1% reduced) when the sparsity reaches 99% while the original ONN obtains 53.8% and the electronic network LeNet obtains 22.3%. The present disclosure concludes that optics own more instinct advantages in sparsity and parallelism than electronics due to massive optical information, achieving equivalent or higher performance while costing fewer computational resources, which naturally demonstrates the potential to mimic efficient biological mechanisms of the human lifelong learning.

Furthermore, a figure c in FIG. 5 investigates how learning sequence impacts the performance of the photonic lifelong learning of the L²ONN. First, the present disclosure trains the L²ONN on each individual task and obtains the photonic neuron activation density in the first layer, which is regarded as an evaluation criteria of the task difficulty grade. Consequently, 5 tasks can be classified into 3 difficulty grades since tasks 1 and 2, and tasks 3 and 4 have similar densities. Under such standard, the L²ONN is trained with 2 extreme training sequences from easy to hard and from hard to easy, and their corresponding accuracy curves are compared in the figure d in FIG. 5. The present disclosure observes that training from easy to hard costs less photonic neuron activation at all steps (23.25% at most) but achieves higher performance on all tasks (10.42% at most) when compared with the training from hard to easy. The L²ONN further proves its human-like characteristics in lifelong learning which requires a step-by-step process to gradually absorb, memorize and consolidate skills, starting from complex tasks will receive opposite effects, just like human always learns creeping before walking. Furthermore, the present disclosure successively shifts the interior sequences of difficulty grades 1 and 2 and reports the evaluation results in the figure e in FIG. 5. Although spatial distributions of the photonic neuron activations show differences, the obtained densities and accuracies barely vary from a basic training sequence (from easy to hard). The L²ONN demonstrates its high learning capability, versatility, and extremely high energy efficiency, providing a key solution for achieving more advanced AI tasks.

In summary, the present disclosure learns each task by adaptively activating sparse photonic neuron connections through the PCM-based optical modulation filters, while gradually acquiring experiential information on various tasks by gradually enlarging the photonic activation map, the multi-task optical features are parallelly processed by the multi-spectrum representations allocated with different wavelengths. Except for the nonlinear activation and the electrical network read-out layer, all calculations are performed using the optics, except for the nonlinear activation and the electrical network read-out layer. A principle of the photonic lifelong learning is inspired by the memory protection mechanism of the brain and accommodating new knowledge by using the sparse neuron connections and the parallel task processing. Optics own more inherent advantages in sparsity and parallelism than electronic computing systems due to the inherent massive optical information, which may naturally mimic the biological mechanisms of the human lifelong learning. Unlike the existing artificial intelligence methods are prone to train new models interfering with formerly learned knowledges, the proposed photonic lifelong learning architecture has capabilities to continuously master multiple tasks and avoids the catastrophic forgetting problem. In short, the present disclosure has demonstrated the proposed L²ONN provides a key solution for large-scale real-life AI applications with unprecedented scalability and versatility. The L²ONN shows its extraordinary learning capability on challenging machine learning tasks, such as the vision classification, the voice recognition and the medical diagnosis, supporting various new environments. The present disclosure anticipates that the proposed method may accelerate the development of more powerful photonic computing as critical support for modern advanced machine intelligence and towards beginning a new era of AI.

The system for the intelligent photonic computing lifelong learning architecture according to embodiments of the present disclosure may achieve multitasking and high-performance machine intelligence. Benefiting from inherent sparsity and parallelism in large-scale photonic connections, the L²ONN naturally mimics lifelong learning mechanisms of neurons and synapses in the human brain. The L²ONN learns each task by adaptively activating sparse photonic connections in the coherent light field, while gradually acquiring experiential information on various tasks by gradually enlarging the activation connections. The multi-task optical features are parallelly processed by multi-spectrum representations allocated with different wavelengths. The present disclosure endows machine intelligence with capabilities to calculate at a speed of light, while making the photonic computing unprecedentedly scalable and versatile.

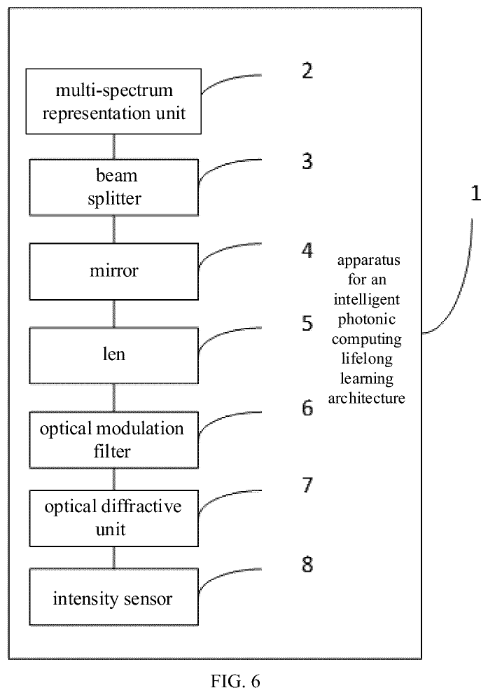

In order to achieve the above embodiments, as illustrated in FIG. 6, an embodiment of the present disclosure also provides an apparatus 1 for an intelligent photonic computing lifelong learning architecture is provided. The apparatus 1 include a multi-spectrum representation unit 2, a beam splitter 3, mirrors 4, lens 5, optical modulation filters 6, an optical diffractive unit 7, and an intensity sensor 8.

Electronic signals including multiple tasks are input into the multi-spectrum representation unit 2 to obtain coherent light with different wavelengths by multi-spectrum representations, light propagation of the coherent light with different wavelengths is guided and modulated through the beam splitter 3, the mirrors 4, the lens 5, the optical modulation filters 6, the optical diffractive unit 7 to obtain final spatial optical signals, the intensity sensor 8 detects the final spatial optical signals to obtain final optical output data, and multi-task recognition results of the final optical output data are obtained through an output plane.

The apparatus for the intelligent photonic computing lifelong learning architecture according to embodiments of the present disclosure may achieve multitasking and high-performance machine intelligence. Benefiting from inherent sparsity and parallelism in large-scale photonic connections, the L²ONN naturally mimics lifelong learning mechanisms of neurons and synapses in the human brain. The L²ONN learns each task by adaptively activating sparse photonic connections in the coherent light field, while gradually acquiring experiential information on various tasks by gradually enlarging the activation connections. The multi-task optical features are parallelly processed by multi-spectrum representations allocated with different wavelengths. The present disclosure endows machine intelligence with capabilities to calculate at a speed of light, while making the photonic computing unprecedentedly scalable and versatile.

In an aspect of the present disclosure, a system for an intelligent photonic computing lifelong learning architecture is provided, and includes a multi-spectrum representation layer, a lifelong learning optical neural network layer, and an electronic network read-out layer, in which,
the multi-spectrum representation layer is configured to transfer originally input electronic signals including multiple tasks into coherent light with different wavelengths by multi-spectrum representations;
the lifelong learning optical neural network layer includes cascaded sparse optical convolutional layers in a Fourier plane of an optical system, in which final spatial optical signals are output through the lifelong learning optical neural network layer by performing multi-task step-by-step training of the lifelong learning optical neural network layer on the coherent light with different wavelengths input into the cascaded sparse optical convolutional layers; and
the electronic network read-out layer is configured to recognize final optical output data obtained by detecting the final spatial optical signals, to obtain multi-task recognition results.

In addition, the system according to the above embodiment of the present disclosure may also have following additional technical features.

Further, in an embodiment of the present disclosure, each layer of the sparse optical convolutional layers includes an optical modulation filter and an optical diffractive unit, in which, the optical system transfers the input coherent light with different wavelengths into sparse optical features and inputs the sparse optical features into the cascaded sparse optical convolutional layers to perform optical convolutional operation, the optical modulation filter is configured to adaptively activate photonic neurons based on sparse optical features after the optical convolutional operation, and input activated photonic neurons into the optical diffractive unit to modulate photonic neuron connections for each single task to output the final spatial optical signals.

Further, in an embodiment of the present disclosure, the electronic network read-out layer is further configured to obtain the final optical output data by detecting the final spatial optical signals on an output plane using an intensity sensor.

Further, in an embodiment of the present disclosure, the optical modulation filter is an phase change materials (PCM)-based sparse optical filter, the PCM includes GeSbTe (GST) cells, each GST cell includes two states of amorphous and crystalline with different spectra transmissions, under a same wavelength, a GST cell with the spectra transmission higher than a predefined threshold is in an activated state, and a GST cell with the spectra transmission lower than the predefined threshold is in an unactivated state.

Further, in an embodiment of the present disclosure, the optical system is a 4f optical system, a multi-task optical feature Uₖ^{λ}^{ⁱ} is a feature representation of a k-th sparse optical convolutional layer on spectrum λⁱ of an i-th task, is Fourier transformed into a following expression by using a first 2f system:

U′ₖ^{λ}^{ⁱ}=FUₖ^{λ}^{ⁱ},
where U′ₖ^{λ}^{ⁱ} represents optical feature mapping in a Fourier domain, and F denotes a Fourier transform matrix; U′ₖ^{λ}^{ⁱ} is modulated by an optical modulation filter:

$${U}_{k}^{{″λ}^{i}} = {I}_{k} ( {λ}^{i} ) {M}_{k} {U}_{k}^{{′λ}^{i}} ,$$

where U″ₖ^{λ}^{ⁱ} represents an optical feature after modulation, Mₖ denotes a phase modulation matrix, Iₖ(λⁱ) denotes intensity modulation matrix; U″ₖ^{λ}^{ⁱ} is Fourier transformed back to a space domain by using a second 2f system, and normalized optical output data Oₖ^{λ}^{ⁱ} is measured by an intensity sensor on an output plane:

$${O}_{k}^{{λ}^{i}} = {\vert {FU}_{k}^{{″λ}^{i}} \vert}^{2} ,$$

except for the electronic network read-out layer, the optical output data Oₖ^{λ}^{ⁱ} of each layer of the sparse optical convolutional layers is remapped as an input of the next layer:

$${U}_{k + 1}^{{λ}^{i}} = remap ( {O}_{k}^{{λ}^{i}} ) ,$$

where remap( ) represents a corresponding non-linear operation to a photonic computing.

Further, in an embodiment of the present disclosure, the electronic network read-out layer is further configured to crop final spatial optical output data Oₙ^{λ}^{ⁱ} detected by the intensity sensor on the output plane into l spatial blocks with a predefined size, and input intensity data of each spatial block into an electronic fully-connected layer to obtain the multi-task recognition results, where n is a number of layers for optical modules.

Further, in an embodiment of the present disclosure, the lifelong learning optical neural network layer is further configured to:
for training of each task on the optical modulation filter, train a dense activation map mapⁱ using a lifelong learning optical neural network, and prune the mapⁱ to a sparse activation map using an intensity threshold thres:

$${map}^{i} [ {map}^{i} < thres ] = 0 ,$$

where mapⁱ denotes an activation map on the i-th task; wherein a photonic neuron with intensity data greater than the intensity threshold remains activated:

$$Δ W [ {map}^{i} ∧ {V}_{m = 1}^{i - 1} {map}^{m} ] = 0 ,$$

where ΔW represents a gradient matrix of backpropagation on optical convolutional weights W, operation ∧ denotes searching coincident cells between two matrixes, operation ∨ denotes gradually merging activation map matrixes;
a loss function of the lifelong learning optical neural network is defined as:

$$L = {L}_{CEN} ( {P}^{i} , {G}^{i} ) + α {\sum }_{k = 1}^{n} ( {‖ {I}_{k} ( {λ}^{i} ) ‖}^{2} + {‖ {M}_{k} ‖}^{2} ) ,$$

where L_{CEN} represents a softmax cross-entropy loss, Pⁱ and Gⁱ denotes network prediction and data truth of the i-th task respectively, and a denotes a normalization coefficient.

Further, in an embodiment of the present disclosure, the optical modulation filter is further configured to share optical weights learned from all tasks.

Further, in an embodiment of the present disclosure, the phase change materials (PCM)-based sparse optical filter is all-optically switched, the phase change materials (PCM)-based sparse optical filter is further configured to perform adaptive photonic neuron activations in spatial and spectrum dimensions on an input optical field.

In another aspect of the present disclosure, an apparatus for an intelligent photonic computing lifelong learning architecture is provided, and includes a multi-spectrum representation unit, a beam splitter, mirrors, lens, optical modulation filters, an optical diffractive unit, and an intensity sensor; in which,
electronic signals including multiple tasks are input into the multi-spectrum representation unit to obtain coherent light with different wavelengths by multi-spectrum representations, light propagation of the coherent light with different wavelengths is guided and modulated through the beam splitter, the mirrors, the lens, the optical modulation filters, the optical diffractive unit to obtain final spatial optical signals, the intensity sensor detects the final spatial optical signals to obtain final optical output data, and multi-task recognition results of the final optical output data are obtained through an output plane.

The system and the apparatus for the intelligent photonic computing lifelong learning architecture in an embodiment of the present disclosure may achieve multitasking and high-performance machine intelligent computing, avoid a catastrophic forgetting issue of ordinary optical neural networks (ONNs), and complete multi-task lifelong learning on multiple challenging tasks such as visual classification, voice recognition, medical diagnosis, etc.

In addition, the present disclosure provides a method for an intelligent photonic computing lifelong learning architecture. The method includes:
transferring, by a multi-spectrum representation layer, originally input electronic signals including multiple tasks into coherent light with different wavelengths by multi-spectrum representations;
performing multi-task step-by-step training of the lifelong learning optical neural network layer on the coherent light with different wavelengths input into cascaded sparse optical convolutional layers and outputting final spatial optical signals through a lifelong learning optical neural network layer, in which the lifelong learning optical neural network layer includes cascaded sparse optical convolutional layers in a Fourier plane of an optical system; and
recognizing, by an electronic network read-out layer, final optical output data obtained by detecting the final spatial optical signals, to obtain multi-task recognition results.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, those skilled in the art may combine and integrate different embodiments or examples described in the description, as well as features of different embodiments or examples, without conflicting with each other.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

What is claimed is:

1. A system for an intelligent photonic computing lifelong learning architecture, comprising a multi-spectrum representation layer, a lifelong learning optical neural network layer, and an electronic network read-out layer, wherein:
the multi-spectrum representation layer is configured to transfer originally input electronic signals comprising multiple tasks into coherent light with different wavelengths by multi-spectrum representations;
the lifelong learning optical neural network layer comprises cascaded sparse optical convolutional layers in a Fourier plane of an optical system, wherein final spatial optical signals are output through the lifelong learning optical neural network layer by performing multi-task step-by-step training of the lifelong learning optical neural network layer on the coherent light with different wavelengths input into the cascaded sparse optical convolutional layers; and
the electronic network read-out layer is configured to recognize final optical output data obtained by detecting the final spatial optical signals, to obtain multi-task recognition results.

2. The system according to claim 1, wherein each layer of the sparse optical convolutional layers comprises an optical modulation filter and an optical diffractive unit, wherein the optical system transfers the input coherent light with different wavelengths into sparse optical features and inputs the sparse optical features into the cascaded sparse optical convolutional layers to perform optical convolutional operation, the optical modulation filter is configured to adaptively activate photonic neurons based on sparse optical features after the optical convolutional operation, and input activated photonic neurons into the optical diffractive unit to modulate photonic neuron connections for each single task to output the final spatial optical signals.

3. The system according to claim 1, wherein the electronic network read-out layer is further configured to obtain the final optical output data by detecting the final spatial optical signals on an output plane using an intensity sensor.

4. The system according to claim 2, wherein the optical modulation filter is a phase change materials (PCM)-based sparse optical filter, the PCM comprises GeSbTe (GST) cells, each GST cell comprises two states of amorphous and crystalline with different spectra transmissions, under a same wavelength, a GST cell with the spectra transmission higher than a predefined threshold is in an activated state, and a GST cell with the spectra transmission lower than the predefined threshold is in an unactivated state.

5. The system according to claim 1, wherein the optical system is a 4f optical system, a multi-task optical feature Uₖ^{λ}^{ⁱ} is a feature representation of a k-th sparse optical convolutional layer on spectrum λⁱ of an i-th task, is Fourier transformed into a following expression by using a first 2f system:
U′ₖ^{λ}^{ⁱ}=FUₖ^{λ}^{ⁱ},
where U′ₖ^{λ}^{ⁱ} represents optical feature mapping in a Fourier domain, and F denotes a Fourier transform matrix; U′ₖ^{λ}^{ⁱ} is modulated by an optical modulation filter:
$${{U}^{″}}_{k}^{{λ}^{i}} = {I}_{k} ( {λ}^{i} ) {M}_{k} {{U}^{′}}_{k}^{{λ}^{i}} ,$$
where U″ₖ^{λ}^{ⁱ} represents an optical feature after modulation, Mₖ denotes a phase modulation matrix, Iₖ(λⁱ) denotes intensity modulation matrix; U″ₖ^{λ}^{ⁱ} is Fourier transformed back to a space domain by using a second 2f system, and normalized optical output data Oₖ^{λ}^{ⁱ} is measured by an intensity sensor on an output plane:
$${O}_{k}^{{λ}^{i}} = {\vert {{FU}^{″}}_{k}^{{λ}^{i}} \vert}^{2} ,$$
except for the electronic network read-out layer, the optical output data Oₖ^{λ}^{ⁱ} of each layer of the sparse optical convolutional layers is remapped as an input of the next layer:
$${U}_{k + 1}^{{λ}^{i}} = remap ( {O}_{k}^{{λ}^{i}} ) ,$$
where remap( ) represents a corresponding non-linear operation to a photonic computing.

6. The system according to claim 5, wherein the electronic network read-out layer is further configured to crop final spatial optical output data Oₙ^{λ}^{ⁱ} detected by the intensity sensor on the output plane into l spatial blocks with a predefined size, and input intensity data of each spatial block into an electronic fully-connected layer to obtain the multi-task recognition results, where n is a number of layers for optical modules.

7. The system according to claim 6, wherein the lifelong learning optical neural network layer is further configured to:
for training of each task on the optical modulation filter, train a dense activation map mapⁱ using a lifelong learning optical neural network, and prune the mapⁱ to a sparse activation map using an intensity threshold thres:
$${map}^{i} [ {map}^{i} < thres ] = 0 ,$$
where mapⁱ denotes an activation map on the i-th task; wherein a photonic neuron with intensity data greater than the intensity threshold remains activated:
$$Δ W [ {map}^{i} ∧ {V}_{m = 1}^{i - 1} {map}^{m} ] = 0 ,$$
where ΔW represents a gradient matrix of backpropagation on optical convolutional weights W, operation ∧ denotes searching coincident cells between two matrixes, operation ∨ denotes gradually merging activation map matrixes; and
a loss function of the lifelong learning optical neural network is defined as:
$$L = {L}_{CEN} ( {P}^{i} , {G}^{i} ) + α {\sum }_{k = 1}^{n} ( {‖ {I}_{k} ( {λ}^{i} ) ‖}^{2} + {‖ {M}_{k} ‖}^{2} ) ,$$
where L_{CEN} represents a softmax cross-entropy loss, Pⁱ and Gⁱ denote network prediction and data truth of the i-th task respectively, and a denotes a normalization coefficient.

8. The system according to claim 7, wherein the optical modulation filter is further configured to share optical weights learned from all tasks.

9. The system according to claim 4, wherein the phase change materials (PCM)-based sparse optical filter is all-optically switched, the phase change materials (PCM)-based sparse optical filter is further configured to perform adaptive photonic neuron activations in spatial and spectrum dimensions on an input optical field.

10. An apparatus for an intelligent photonic computing lifelong learning architecture, comprising a multi-spectrum representation unit, a beam splitter, mirrors, lens, optical modulation filters, an optical diffractive unit, and an intensity sensor;
wherein electronic signals comprising multiple tasks are input into the multi-spectrum representation unit to obtain coherent light with different wavelengths by multi-spectrum representations, light propagation of the coherent light with different wavelengths is guided and modulated through the beam splitter, the mirrors, the lens, the optical modulation filters, the optical diffractive unit to obtain final spatial optical signals, the intensity sensor detects the final spatial optical signals to obtain final optical output data, and multi-task recognition results of the final optical output data are obtained through an output plane.

11. The apparatus according to claim 10, wherein the coherent light with different wavelengths is transferred into sparse optical features and the sparse optical features are input into cascaded sparse optical convolutional layers to perform optical convolutional operation, each optical modulation filter is configured to adaptively activate photonic neurons based on sparse optical features after the optical convolutional operation, and input activated photonic neurons into the optical diffractive unit to modulate photonic neuron connections for each single task to output the final spatial optical signals.

12. The apparatus according to claim 11, wherein each optical modulation filter is a phase change materials (PCM)-based sparse optical filter, the PCM comprises GeSbTe (GST) cells, each GST cell comprises two states of amorphous and crystalline with different spectra transmissions, under a same wavelength, a GST cell with the spectra transmission higher than a predefined threshold is in an activated state, and a GST cell with the spectra transmission lower than the predefined threshold is in an unactivated state.

13. The apparatus according to claim 11, wherein a multi-task optical feature Uₖ^{λ}^{ⁱ} is a feature representation of a k-th sparse optical convolutional layer on spectrum λⁱ of an i-th task, is Fourier transformed into a following expression by using a first 2f system:
U′ₖ^{λ}^{ⁱ}=FUₖ^{λ}^{ⁱ},
where U′ₖ^{λ}^{ⁱ} represents optical feature mapping in a Fourier domain, and F denotes a Fourier transform matrix; U′ₖ^{λ}^{ⁱ} is modulated by an optical modulation filter:
$${{U}^{″}}_{k}^{{λ}^{i}} = {I}_{k} ( {λ}^{i} ) {M}_{k} {{U}^{′}}_{k}^{{λ}^{i}} ,$$
where U″ₖ^{λ}^{ⁱ} represents an optical feature after modulation, Mₖ denotes a phase modulation matrix, Iₖ(λⁱ) denotes intensity modulation matrix; U″ₖ^{λ}^{ⁱ} is Fourier transformed back to a space domain by using a second 2f system, and normalized optical output data Oₖ^{λ}^{ⁱ} is measured by an intensity sensor on an output plane:
$${O}_{k}^{{λ}^{i}} = {\vert {{FU}^{″}}_{k}^{{λ}^{i}} \vert}^{2} ,$$
except for an electronic network read-out layer, the optical output data Oₖ^{λ}^{ⁱ} of each layer of the sparse optical convolutional layers is remapped as an input of the next layer:
$${U}_{k + 1}^{{λ}^{i}} = remap ( {O}_{k}^{{λ}^{i}} ) ,$$
where remap( ) represents a corresponding non-linear operation to a photonic computing.

14. The apparatus according to claim 13, wherein final spatial optical output data Oₙ^{λ}^{ⁱ} detected by the intensity sensor on the output plane is cropped into 1 spatial blocks with a predefined size, and input intensity data of each spatial block into an electronic fully-connected layer to obtain the multi-task recognition results, where n is a number of layers for optical modules.

15. The apparatus according to claim 14, wherein:
for training of each task on the optical modulation filter, a dense activation map mapⁱ is trained using a lifelong learning optical neural network, and the mapⁱ is pruned to a sparse activation map using an intensity threshold thres:
$${map}^{i} [ {map}^{i} < thres ] = 0 ,$$
where mapⁱ denotes an activation map on the i-th task; wherein a photonic neuron with intensity data greater than the intensity threshold remains activated:
$$Δ W [ {map}^{i} ∧ {V}_{m = 1}^{i - 1} {map}^{m} ] = 0 ,$$
where ΔW represents a gradient matrix of backpropagation on optical convolutional weights W, operation ∧ denotes searching coincident cells between two matrixes, operation ∨ denotes gradually merging activation map matrixes; and
a loss function of the lifelong learning optical neural network is defined as:
$$L = {L}_{CEN} ( {P}^{i} , {G}^{i} ) + α {\sum }_{k = 1}^{n} ( {‖ {I}_{k} ( {λ}^{i} ) ‖}^{2} + {‖ {M}_{k} ‖}^{2} ) ,$$
where L_{CEN} represents a softmax cross-entropy loss, Pⁱ and Gⁱ denote network prediction and data truth of the i-th task respectively, and a denotes a normalization coefficient.

16. The apparatus according to claim 15, wherein the optical modulation filter is further configured to share optical weights learned from all tasks.

17. The apparatus according to claim 12, wherein the phase change materials (PCM)-based sparse optical filter is all-optically switched, the phase change materials (PCM)-based sparse optical filter is further configured to perform adaptive photonic neuron activations in spatial and spectrum dimensions on an input optical field.

18. A method for an intelligent photonic computing lifelong learning architecture, comprising:
transferring, by a multi-spectrum representation layer, originally input electronic signals comprising multiple tasks into coherent light with different wavelengths by multi-spectrum representations;
performing multi-task step-by-step training of a lifelong learning optical neural network layer on the coherent light with different wavelengths input into cascaded sparse optical convolutional layers and outputting final spatial optical signals through the lifelong learning optical neural network layer, wherein the lifelong learning optical neural network layer comprises cascaded sparse optical convolutional layers in a Fourier plane of an optical system; and
recognizing, by an electronic network read-out layer, final optical output data obtained by detecting the final spatial optical signals, to obtain multi-task recognition results.
